(19) United States
(12) Patent Application Publication
(10) Pub. No.: US 2007/0201507 A1
(43) Pub. Date: Aug. 30, 2007

(54) Frame transmitting/receiving method and device

(75) Inventors: Yukio Yamazaki, Kawasaki (JP); Masato Hori, Kawasaki (JP); Waki Iwata, Kawasaki (JP)

Correspondence Address: BINGHAM MCCUTCHEN LLP, 2020 K Street, N.W., Intellectual Property Department, WASHINGTON, DC, 20006, US

(73) Assignee: FUJITSU LIMITED

(21) Appl. No.: 11/502,536

(22) Filed: Aug. 11, 2006

(30) Foreign Application Priority Data
Feb. 27, 2006 (JP) 2006-050735

(51) Int. Cl. H04J 15/00

(52) U.S. Cl. 370/464

(57) ABSTRACT

A frame transmitting method and device insert a channel identifier into predetermined free bytes of parallel channel signals whose phases are different from each other without a phase adjustment, and convert the parallel channel signals into a serial signal to transmit a frame. A frame receiving method and device convert a serial signal whose phase is not adjusted on the transmission side into parallel channel signals, detect a frame pattern from a single channel signal within the parallel channel signals to detect a channel identifier inserted into a predetermined free byte of the single channel signal, and further rearrange channels between all of the parallel channel signals without a phase adjustment, based on the channel identifier.

### BACKGROUND OF THE INVENTION

1. Field of the Invention

The present invention relates to a frame transmitting/receiving method and device, and in particular to a method and device for transmitting/receiving STS-N or STM-N frames whose phases are different from each other.

2. Description of the Related Art

FIG. 17 shows a prior art example of a frame transmitting device in which a plurality of parallel STS-N (SONET (Synchronous Optical Network) system: N=1, 3 . . . ) signals or STM-N (SDH (Synchronous Digital Hierarchy) system: N=0, 1, . . . ) signals (hereinafter, represented by STS-N signals) whose phases are different from each other are converted into a serial STS-N signal to be transmitted. FIG. 18 shows a prior art frame receiving device converting the serial STS-N signal into the parallel STS-N signals corresponding to the frame transmitting device.

In the frame transmitting device shown in FIG. 17, 2 groups (=2 channels in this example) of an STS-1 frame where N=1, i.e. an STS1-CH1 frame and an STS1-CH2 frame (respectively parallel 8 bits) are inputted to a phase adjustment circuit 21. The phase adjustment circuit 21 absorbs a phase difference between the channels CH1 and CH2 by using a RAM or the like having the capacity of one frame, and transmits, to a frame pattern/CH identifier inserting circuit 22, 16-bit parallel STS1 frames in which head positions of the frames are adjusted.

The frame pattern/CH identifier inserting circuit 22 incorporates or maps the 16-bit parallel STS1 frames whose phases are adjusted by the phase adjustment circuit 21 into a larger (upper layer) STS frame.

FIGS. 19A and 19B show a mapping image to the upper layer at this time. The STS1-CH1 and the STS1-CH2 shown by hatching in FIG. 19A are mapped to e.g. an STS3 frame part shown by hatching in FIG. 19B. In the STS3 frame, a CH identifier corresponding to each channel is inserted into a predetermined free byte, and an overhead byte such as SOH and LOH are added to the frame to be transmitted to a scrambler 23.

The scrambler 23 removes the overhead byte from the STS3 frame received, and scrambles the frame to be transmitted to a P/S (parallel/serial) conversion circuit 24. This P/S conversion circuit 24 converts the parallel 16-bit STS3 frame extending across 2 groups of the channels CH1 and CH2 into channel-multiplexed and bit-multiplexed serial data to be transmitted.

In the frame receiving device shown in FIG. 18, the serial data of the STS3 frame transmitted from the frame transmitting device shown in FIG. 17 and to which the bit-multiplexing is performed for two channels is converted into a 16-bit parallel data signal by an S/P (serial/parallel) conversion circuit 31. The 16-bit parallel data signal is transmitted to a frame synchronization circuit 32, where a frame pattern FP and the CH (channel) identifier inserted into the predetermined free byte by the frame pattern/CH identifier inserting circuit 22 shown in FIG. 17 are detected at the same time. The CH identifier is transmitted to a CH adjusting circuit 33.

The CH adjusting circuit 33 converts the 16-bit parallel signals (STS3 frame) from the S/P conversion circuit 31 into the STS1 frames. In view of a possibility of an order difference between the channels upon the conversion, the CH adjusting circuit 33 performs rearrangement per channel to a channel corresponding to a transmission side based on the CH identifier detected by the frame synchronization circuit 32, where a bit order within each channel is supposed to be unchanged on a transmission line or the like; the same applies to the following description.

As a result, an 8-bit parallel STS1-CH1 frame signal and an STS1-CH2 frame signal are outputted from the CH adjusting circuit 33 (see e.g. patent document 1).
[Patent document 1] Japanese Patent Application Laid-open No.2001-197031

In the above-mentioned prior art, for the sake of simplification of the arrangement of the frame receiving device, the frame transmitting device is provided with the phase adjustment circuit for changing the STS-N signal to the frame at the upper layer, in which the phase difference between the different STS-N frames is absorbed.

However, such a phase adjustment circuit requires frame memories for e.g. 1 frame×the number of multiplexed channels. On the other hand, the reception side requires a frame synchronization circuit receiving the frame of an STS size for the upper layer before demultiplexing the STS-N signal.

Also, for multiplexing into an upper layer frame, an addition of an overhead byte is required, which leads to a larger size of the STS frame, and a high speed within the frame. Therefore, it has been disadvantageous that a PLL oscillator and its peripheral circuit are required for the enhancement of the transmission rate, which leads to an increase of the number of parts and power consumption.

In addition, the increase of the number of parallel processings is forced on the reception side due to a restriction of an operation rate of a device to be used as the transmission rate is enhanced, and “N” kinds of frame head positions exist in the frame synchronization circuit of the parallel signals, requiring a complicated and large-scale frame synchronization circuit.

### SUMMARY OF THE INVENTION

It is accordingly an object of the present invention to provide a frame transmitting/receiving method and device which do not require a phase adjustment for absorbing a phase difference between different frames.

[1] In order to achieve the above-mentioned object, a frame transmitting method (device) according to one aspect of the present invention comprises: a first step of (means) inserting a channel identifier without a phase adjustment into predetermined free bytes of parallel channel signals whose phases are different from each other; and a second step of (means) converting the parallel channel signals into a serial signal.

Namely, in one aspect of the present invention, when parallel channel signals whose phases are different from each other are converted into a serial signal to be transmitted, a channel (CH) identifier is inserted into predetermined free bytes of the parallel channel signals without a phase adjustment. Accordingly, the parallel channel signals inputted with the phase difference are converted into the serial signal to be transmitted.

Accordingly, a phase adjustment for adjusting the phases of the parallel channel signals is not required, and the parallel signals are converted into a serial signal to be transmitted without being multiplexed into a larger (upper layer) frame size, thereby realizing a simple frame transmitting method.

[2] Also, in a frame receiving method (device) according to one aspect of the present invention comprises: a first step of (means) converting a serial signal whose phase is not adjusted on a transmission side into parallel channel signals; a second step of (means) detecting a frame pattern from a single channel signal within the parallel channel signals to detect a channel identifier inserted into a predetermined free byte of the single channel signal; and a third step of (means) rearranging channels between all of the parallel channel signals without a phase adjustment, based on the channel identifier.

Namely in one aspect of the present invention, when the received serial signal is converted into parallel channel signals, the phase of the serial signal is not adjusted on the transmission side. A frame pattern (frame synchronization signal) is detected from a single channel signal of the parallel channel signals, so that a channel identifier inserted into a predetermined free byte of the single channel signal on the transmission side is detected together with the frame pattern detection. Based on this channel identifier, a channel rearrangement is performed between all of the parallel channel signals obtained by the above-mentioned first step (means).

Thus, in the frame receiving method (device) according to one aspect of the present invention, a channel identifier is extracted to recognize channel information after a frame synchronization of the parallel channel signals by the frame pattern is established, thereby enabling all of the signals multiplexed to be demultiplexed.

[3] Also, in the frame transmitting method (device) according to one aspect of the present invention, the second step (means) may include a step of (means) inverting signals of odd number channels or even number channels within the parallel channel signals and then converting the signals into the serial signal.

Thus, even if the frame information with the same pattern and to which scramble processing is not performed continues due to a signal inversion of odd number channels or even number channels, it is made possible to prevent the reduction of a mark ratio of the signals.

[4] Also, in the frame receiving method (device) according to one aspect of the present invention, the third step (means) may include a step of (means) further inverting signals of odd number channels or even number channels within all of the channel signals rearranged.

Namely, in the same way as the above-mentioned [3], when signals of the odd number channels or even number channels are inverted and transmitted as a serial signal, the signals of the odd number channels or even number channels are reversed correspondingly on the receiving side. Thus, upon conversion into parallel data, data of every other channel is inverted corresponding to a case where data inversion processing is performed on the transmission side, so that the data on the transmission side can be received without the reduction of the mark ratio.

[5] Also, the frame receiving method (device) according to one aspect of the present invention may further comprise a fourth step of (means) detecting another corresponding frame pattern from a single channel signal within groups other than a group to which the single channel signal belongs among predetermined m (m≧2) number of groups whose phases are different from each other, composing the parallel channel signals; and a fifth step of (means) rearranging the frame patterns detected at the second and fourth step (means) respectively, based on the channel identifier.

Namely, in the frame receiving method (device) according to one aspect of the present invention, the frame pattern is detected from a single channel signal in the above-mentioned [2]. However, if the parallel channel signals received are composed of predetermined m (m≧2) groups whose phases are different from each other, another frame pattern corresponding to the latter group is detected from a single channel signal within groups other than a group to which the above-mentioned single channel signal belongs. The frame patterns detected at the second step (means) and the fourth step (means) respectively are rearranged based on the channel identifier already detected.

Thus, it becomes possible to easily detect the frame pattern of each group from a single channel signal within “m” groups whose phases are different from each other, and to rearrange the frame patterns based on the channel identifier to be outputted.

[6] Also, the frame receiving method (device) according to one aspect of the present invention may further comprise a sixth step of (means) generating an MSB timing based on the frame pattern detected at the second step; and a seventh step of (means) performing MSB adjusting of the parallel channel signals based on the MSB timing before the channel rearrangement at the third step (means).

Namely, by using the frame pattern detected by the above-mentioned [5], an MSB (most significant bit) timing can be generated. Based on this MSB timing, an MSB adjusting of the parallel channel signals can be performed before the above-mentioned channel rearrangement.

[7] It is to be noted that signals of STS-N or STM-N may be used for the above-mentioned parallel channel signal and the serial signal.

According to the present invention, when a serial transmission is performed to the parallel channel signals of a plurality of groups whose phases are different from each other, the parallel channel signals can be converted into serial data without adjustments of the phases of the parallel channel signals in the groups and without a conversion into a larger frame size which causes a circuit increase. Also, it is made possible to easily demultiplex the signals to which the channel-multiplexing is performed on the reception side without causing the increase of the circuit.

Also, polarity of a specific parallel signal is inverted on the transmission side, and then bit-multiplexing is performed to the serial data, thereby enabling the reduction of the signal mark ratio on the transmission line which occurs when codes of the parallel signals inputted happen to be consistent with each other to be prevented.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a block diagram showing an embodiment [1] (in case of 2-channel multiplexing) of a frame transmitting device realizing a frame transmitting method according to one aspect of the present invention;

FIGS. 2A and 2B are diagrams showing a checking bit position in an STS1 frame and an STS3 frame;

FIG. 3 is a block diagram showing an embodiment [1] (in case of 2-channel multiplexing) (No. 1) of a frame receiving device realizing a frame receiving method according to one aspect of the present invention;

FIG. 4 is a block diagram showing an embodiment [1] (in case of 2-channel multiplexing) (No.2) of a frame receiving device realizing a frame receiving method according to one aspect of the present invention;

FIG. 5 is a transition diagram of a synchronization protection state in a frame synchronization/CH identification circuit and a frame synchronization circuit used for a frame receiving device in one aspect of the present invention;

FIGS. 6A-6C are diagrams showing an MSB adjusting operation example of bytes in a frame receiving device in one aspect of the present invention;

FIG. 7 is a block diagram showing an embodiment [2] (in case of 2-channel multiplexing) of a frame transmitting device realizing a frame transmitting method according to one aspect of the present invention;

FIG. 8 is a block diagram showing an embodiment [2] of a frame receiving device realizing a frame receiving method according to one aspect of the present invention;

FIG. 9 is a block diagram showing an embodiment [3] of a frame transmitting device realizing a frame transmitting method according to one aspect of the present invention;

FIG. 10 is a diagram showing an STS3 frame used for the present invention and its scramble field;

FIGS. 11A and 11B are sequence diagrams showing an operation example in the embodiment [3] of the frame transmitting device shown in FIG. 9;

FIGS. 12A-12C are time charts showing a P/S conversion operation example (phase shift is not shown) in the embodiment [3] of the frame transmitting device shown in FIG. 9;

FIG. 13 is a block diagram showing an embodiment [3] of a frame receiving device realizing a frame receiving method according to one aspect of the present invention;

FIGS. 14A-14E are time charts (MSB adjusting and phase shift are not shown) showing an operation example of the embodiment [3] of the frame receiving device shown in FIG. 13;

FIG. 15 is a block diagram showing an embodiment [4] of a frame transmitting device realizing a frame transmitting method according to one aspect of the present invention;

FIG. 16 is a block diagram showing an embodiment [4] of a frame receiving device realizing a frame receiving method according to one aspect of the present invention;

FIG. 17 is a block diagram showing a prior art frame transmitting device;

FIG. 18 is a block diagram showing a prior art frame receiving device; and

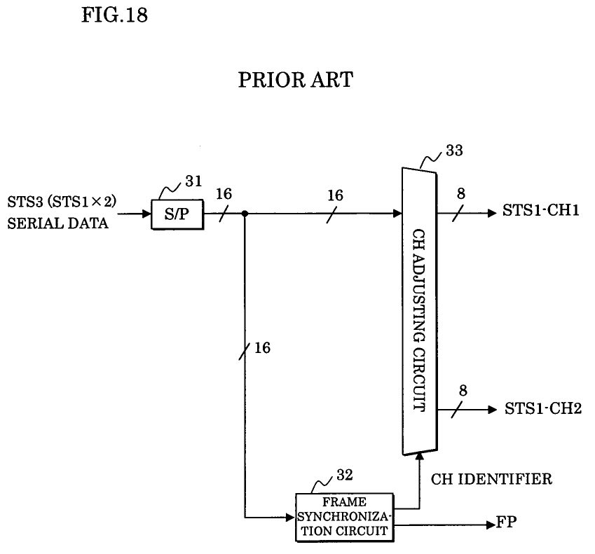

FIGS. 19A and 19B are mapping image diagrams to an upper layer in the prior art example.

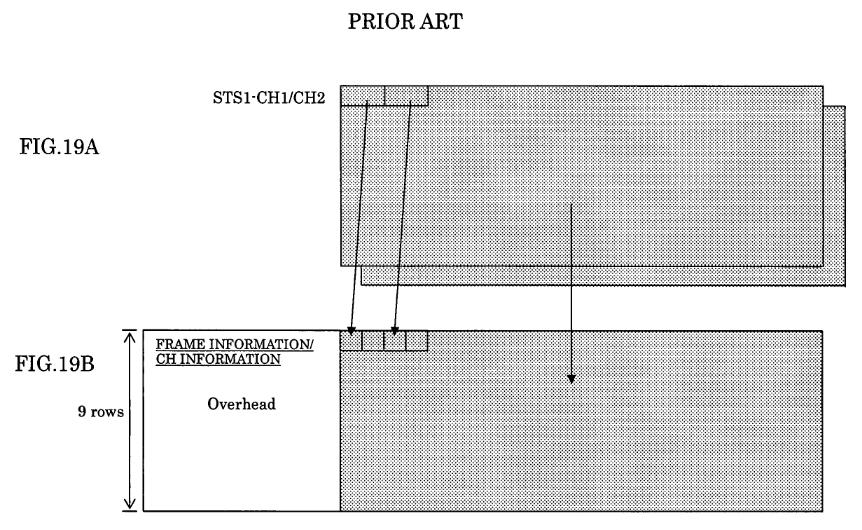

### DESCRIPTION OF THE EMBODIMENTS

Hereinafter, embodiments of a frame transmitting device and frame receiving device for realizing a frame transmitting method and frame receiving method according to the present invention will be described referring to the attached figures. At this time, it is supposed that an STS-N (N=1, 3, . . . ) frame is used as a signal, and specifically an STS frame in the case of N=1 or 3 will be described in the following embodiments, where the present invention is not limited to these embodiments.

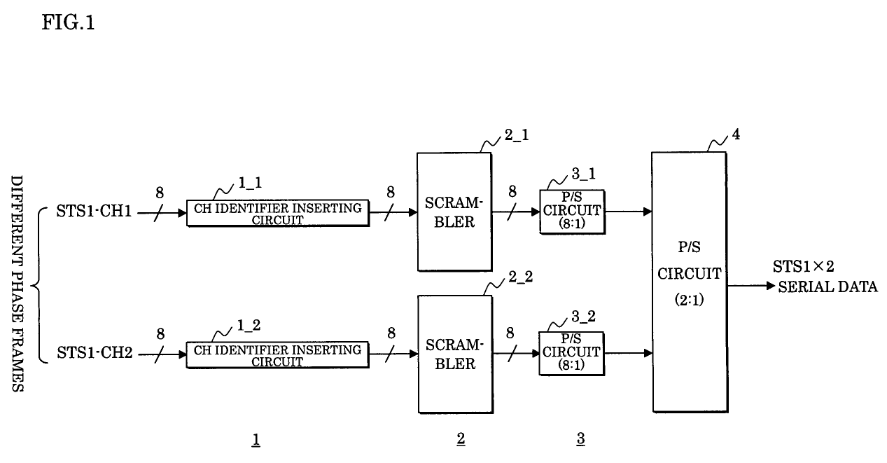

### Embodiment [1] of Frame Transmitting Device: FIG. 1

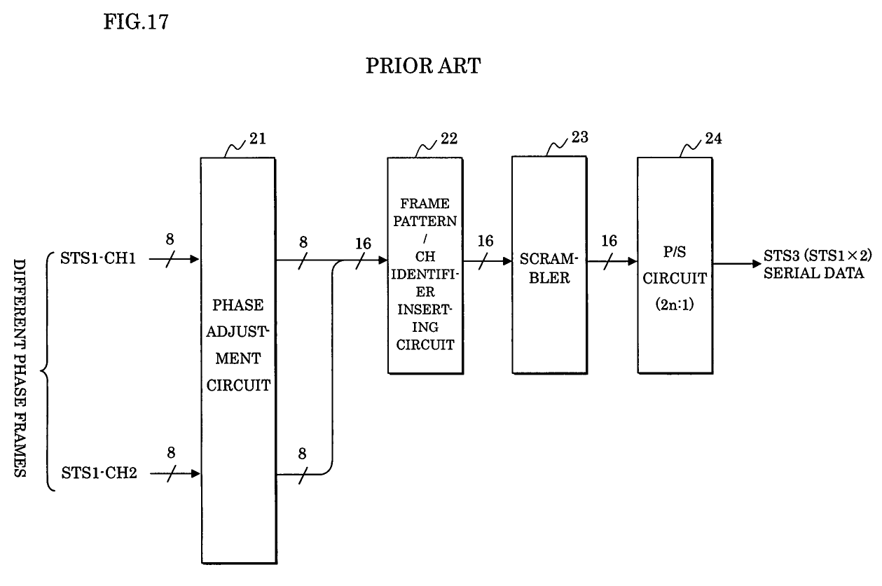

FIG. 1 shows a frame transmitting device for realizing a frame transmitting method according to one aspect of the present invention, and specifically shows an embodiment in the case of 2-channel multiplexing (2-group (system) multiplexing) in the same way as the prior art example of FIG. 17. Namely, an STS1-CH1 frame (parallel 8 bits) of one group and an STS1-CH2 frame (parallel 8 bits) of the other group whose phases are different from each other are inputted. It is supposed that a pair of 8-bit parallel data of the STS1-CH1 frame and the STS1-CH2 frame of the frame transmitting device are inputted respectively in a normal order.

The frame transmitting device is arranged so that the STS1-CH1 frame and the STS1-CH2 frame are respectively inputted to a common P/S circuit 4 through CH identifier inserting circuits 1_1 and 1_2 (hereinafter, occasionally represented by a reference numeral “1”), scramblers 2_1 and 2_2 (hereinafter, occasionally represented by a reference numeral “2”), and P/S conversion circuits 3_1 and 3_2 (hereinafter, occasionally represented by a reference numeral “3”), so that the frames are outputted as serial data. It is to be noted that a channel forms a group in this embodiment as mentioned above.

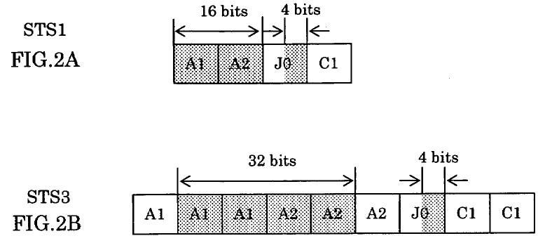

The CH identifier inserting circuit 1 inserts a CH identifier into least significant 4 bits of J0 byte, which is a free byte, within the overhead of the STS1 frame shown in FIG. 2A, for the 8-bit parallel STS1 frame data inputted.

One example of a CH identification pattern at this time is shown in the following Table 1.

TABLE 1

| LEAST SIGNIFICANT 4 | |
|---|---|
| BITS OF J0 BYTE | CH IDENTIFICATION |
| 0000 | CH1 |
| 0001 | CH2 |

The 8-bit parallel signals outputted from the CH identifier inserting circuit 1 undergo the same processing as that of the prior art frame transmitting device shown in FIG. 17 through the scrambler 2 and the P/S conversion circuit 3. Then, the serial data that are the STS1 frames for 2 channels (groups) bit-multiplexed is transmitted by the P/S conversion circuit 4.

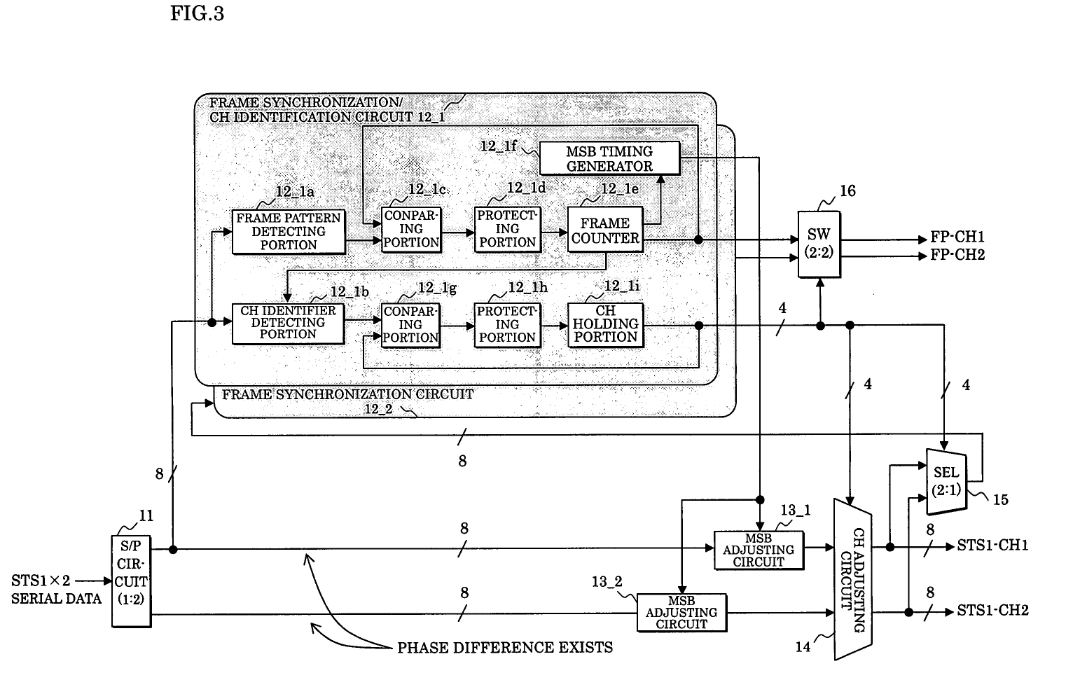

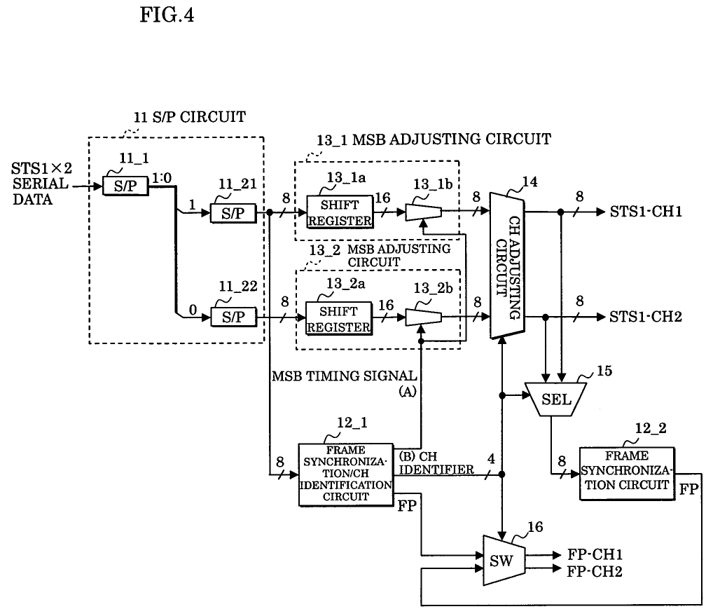

### Embodiment [1] of Frame Receiving Device: FIGS. 3 and 4

This frame receiving device is composed of an S/P conversion circuit 11 receiving the serial data obtained after the STS1 signals of 2 channels (m=2 groups) transmitted from the frame transmitting device shown in FIG. 1 are bit-multiplexed and converting the serial data into the parallel data per 8-bit channel (group), a frame synchronization/CH identification circuit 12_1 detecting a frame pattern based on output parallel signals from the S/P conversion circuit 11 to be outputted and generating a CH identifier and an MSB timing signal based on the frame pattern, MSB adjusting circuits 13_1 and 13_2 respectively adjusting MSBs of the 8-bit parallel channel signals from the S/P conversion circuit 11 based on the MSB timing signal from the frame synchronization/CH identification circuit 12_1, a CH adjusting circuit 14 performing a channel (group) adjusting (rearrangement) of the 8-bit parallel channel (group) signals outputted from the MSB adjusting circuits 13_1 and 13_2 based on the CH identifier (4 bits) from the frame synchronization/CH identification circuit 12_1 to be outputted in parallel, a selector (SEL) 15 inputting the parallel 8-bit STS1-CH1 frame and the STS1-CH2 frame outputted from the CH adjusting circuit 14 and selecting one of them based on the above-mentioned CH identifier, a frame synchronization circuit 12_2 generating only a frame pattern FP (not generate CH identifier and MSB timing signal) of a corresponding channel (group) based on the parallel 8-bit channel signal from the selector 15, and a switch circuit (SW) 16 selecting the frame pattern FP from the frame synchronization/CH identification circuit 12_1 and the frame pattern FP from the frame synchronization circuit 12_2 based on the above-mentioned CH identifier corresponding to the channel CH1 or CH2 to be outputted.

The frame synchronization/CH identification circuit 12_1 further includes a frame pattern detecting portion 12_1a and a CH identifier detecting portion 12_1b inputting one of 2 channels (groups) 8-bit parallel data outputted from the S/P conversion circuit 11, a comparing portion 12_1c comparing a frame pattern detected by the frame pattern detecting portion 12_1a with a frame pattern previously detected to determine whether or not both are consistent, a protecting portion 12_1d monitoring comparison results of the comparing portion 12_1c for a plurality of frames and checking their continuity, a frame counter 12_1e providing the output to the comparing portion 12_{—1}c until the protecting portion 12_1d checks continuity of the frame pattern detection for predetermined frames (the number of protection stages) and generating the frame pattern FP signal when the protecting portion 12_1d confirms the continuity of the frame pattern detection, and an MSB timing generator 12_1f generating the MSB timing signal based on the frame pattern FP signal from the frame counter 12_1e.

Also, the frame synchronization/CH identification circuit 12_1 has a similar arrangement for the CH identifier, and includes a comparing portion 12_1g detecting the CH identifier detected by the CH identifier detecting portion 12_1b for the predetermined number of protection stages with the detection of the frame pattern by the frame counter 12_1e as a trigger, a protecting portion 12_1h, and a CH holding portion 12_1i.

The frame pattern FP from the frame counter 12_1e is transmitted to the switch circuit 16. The CH identifier (4 bits) from the CH holding portion 12_1i is transmitted to the CH adjusting circuit 14, the selector 15, and the switch circuit 16. Also, the MSB timing signal generated by the MSB timing generator 12_1f is commonly transmitted to the MSB adjusting circuits 13_1 and 13_2.

Also, the frame synchronization circuit 12_2, whose internal arrangement is not shown, has portions similar to the frame pattern detecting portion 12_1a, the comparing portion 12_1c, the protecting portion 12_1d, and the frame counter 12_1e in the frame synchronization/CH identification circuit 12_1, where the frame pattern FP is provided to the switch circuit 16 from the frame counter.

It is to be noted that since a signal after the heads of the signals are adjusted to or matched with the MSB by the MSB adjusting circuit 13_1 or 13_2 is inputted to the frame synchronization circuit 12_2, it is not necessary to detect eight synchronization patterns and so a single frame pattern has only to be detected.

FIG. 4 specifically shows in more detail the S/P conversion circuit 11 and the MSB adjusting circuits 13_1 and 13_2 in the embodiment [1] of the frame receiving device shown in FIG. 3.

Namely, as shown in FIG. 4, the S/P conversion circuit 11 is composed of an S/P conversion circuit 11_1 for demultiplexing per 1 bit the STS1 serial data bit-multiplexed for 2 channels (groups), and S/P conversion circuits 11_21 and 11_22 for converting the signals bit-demultiplexed at each channel by the S/P conversion circuit 11_1 into 8-bit parallel channel signals.

Also, the MSB adjusting circuit 13_1 is provided with a shift register 13_1a accumulating for two times the 8-bit parallel channel signals from the S/P conversion circuit 11_21 in the S/P conversion circuit 11 to be converted into 16-bit parallel data, and a selector 13_1b for MSB adjusting the 16-bit parallel data from the shift register 13_1a based on an MSB timing signal (A) from the frame synchronization/CH identification circuit 12_1. Similarly, the MSB adjusting circuit 13_2 is provided with a shift register 13_2a and a selector 13_2b for MSB adjusting the 8-bit parallel signals from the S/P conversion circuit 11_22 in the same way as the above-mentioned MSB adjusting circuit 13_1.

In operation of the frame receiving device, the STS1 serial data of 2 channels (groups) transmitted is converted into the 8-bit parallel data of each channel by the S/P conversion circuit 11. Then, the 8-bit parallel data of one channel is provided to the frame pattern detecting portion 12_1a and the CH identifier detecting portion 12_1b in the frame synchronization/CH identification circuit 12_1.

One example of a frame synchronization condition in the frame pattern detecting portion 12_1a is shown in the following Table 2.

TABLE 2

| FRAME SYNCHRONIZATION | PATTERN RETRIEVAL | SYNCHRONIZATION |
|---|---|---|
| PATTERN | METHOD | PROTECTION |
| A1: 11110110 A2: 00101000 | 1-BIT IMMEDIATE SHIFT | FORWARD 5 STAGES |
| | METHOD | BACKWARD 2 STAGES |
| | 16 BITS OF A1 & A2 BYTES | INCLUDING |
| | CONCURRENT CHECKING | CONSISTENCY OF LEAST |
| | METHOD | SIGNIFICANT 4 BITS OF |
| | | J0 IN PROTECTION |

Namely, the frame synchronization pattern is composed of 16 bits in total, A1 byte=“11110110”, and A2 byte=“00101000” in the STS1 frame. For the pattern retrieving method at this time, a single bit immediate shift method, or a concurrent checking method can be applied.

Also, as for the frame pattern detected by the frame pattern detecting portion 12_1a, as mentioned above, it is monitored whether or not the frame patterns of a predetermined number of protection stages are continuously detected by the comparing portion 12_1c, the protecting portion 12_1d, and the frame counter 12_1e. The synchronization protection at this time has, as shown by the above-mentioned Table 2, forward 5 stages and backward 2 stages, and includes checking the consistency of least significant 4 bits of J0 byte.

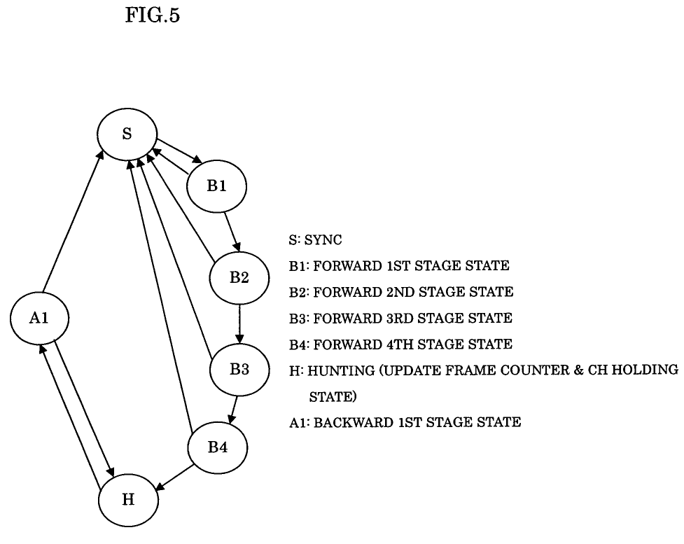

FIG. 5 shows a transition diagram of such a synchronization protection state, and shows which route should be taken, i.e. a forward 5-stage route starting from a synchronization state S to the synchronization state S through a forward 1st stage state B1, a forward 2nd stage state B2, a forward 3rd stage state B3, and a forward 4th stage state B4, or a backward 2-stage route from a hunting state H to the synchronization state S through a backward 1st stage state A1 or back to the hunting state H.

Thus, the frame pattern FP is outputted from the frame counter 12_1 to be transmitted to the switch circuit 16. Concurrently, the MSB timing signal is generated by the MSB timing generator 12_1f upon detection of the frame pattern FP to be commonly provided to the MSB adjusting circuits 13_1 and 13_2.

Also, as for the CH identifier, the CH identifier detecting portion 12_1b detects the CH identifier from the least significant 4 bits of the J0 byte in the STS1 frame shown in FIG. 2A. When the continuity of the CH identifier detected (4 bits in Table 1) is monitored for a predetermined number of protection stages by the comparing portion 12_1g, the protecting portion 12_1h, and the CH holding portion 12_1i, and then the consistency of the CH identifier is detected by the predetermined number of protection stages, the CH identifier (4 bits of Table 1) is provided to the CH adjusting circuit 14, the selector 15, and the switch circuit 16.

When this CH identifier is transmitted to the CH adjusting circuit 14, the CH adjusting circuit 14 adjusts (rearranges) channels so that the parallel 8-bit signals of the channels (groups) from the MSB adjusting circuits 13_1 and 13_2 are normally outputted, in which the upper side corresponds to a channel CH1 and the lower side corresponds to the channel CH2.

It is to be noted that while the MSB adjusting operation is performed in the former stage of the CH adjusting circuit 14 by the MSB adjusting circuits 13_1 and 13_2, the MSB adjusting operation is not directly related to the channel adjusting operation. Therefore, even without the MSB adjusting circuits 13_1 and 13_2, the CH adjusting circuit 14 can accurately perform a channel adjustment to the 8-bit series data of each channel from the S/P conversion circuit 11.

Thus, the STS1 frame of the channel CH1 and the STS1 frame of the channel CH2 accurately outputted from the CH adjusting circuit 14 are also transmitted to the selector 15 concurrently. Since the selector 15 can recognize from its memory (not shown) which channel is presently selected for the CH identifier, the selector 15 selects the data of the other channel different from one channel (CH1 in this example) having already detected the frame pattern FP. Accordingly, the selector 15 selects the STS1 frame of the channel CH2 to be transmitted to the frame synchronization circuit 12_2. It is to be noted that in a case where the S/P conversion circuit 11 divides the input into two groups like the embodiment of the present invention, the selector 15 need not be used, and lower 8-bit parallel outputs of the CH adjusting circuit 14 may be provided unchanged to the frame synchronization circuit 12_2.

Thus, the frame synchronization circuit 12_2 detects the frame pattern FP by the frame pattern detecting portion, the comparing portion, the protecting portion, and the frame counter (not shown) in the same way as the frame synchronization/CH identification circuit 12_1, and transmits the frame pattern FP to the switch circuit 16.

The switch circuit 16 determines which frame pattern is for the channel CH1 based on the CH identifier, outputs the frame pattern FP of the channel CH1 to the upper side, and outputs the frame pattern FP of the channel CH2 from the lower side so as to correspond to the transmission side.

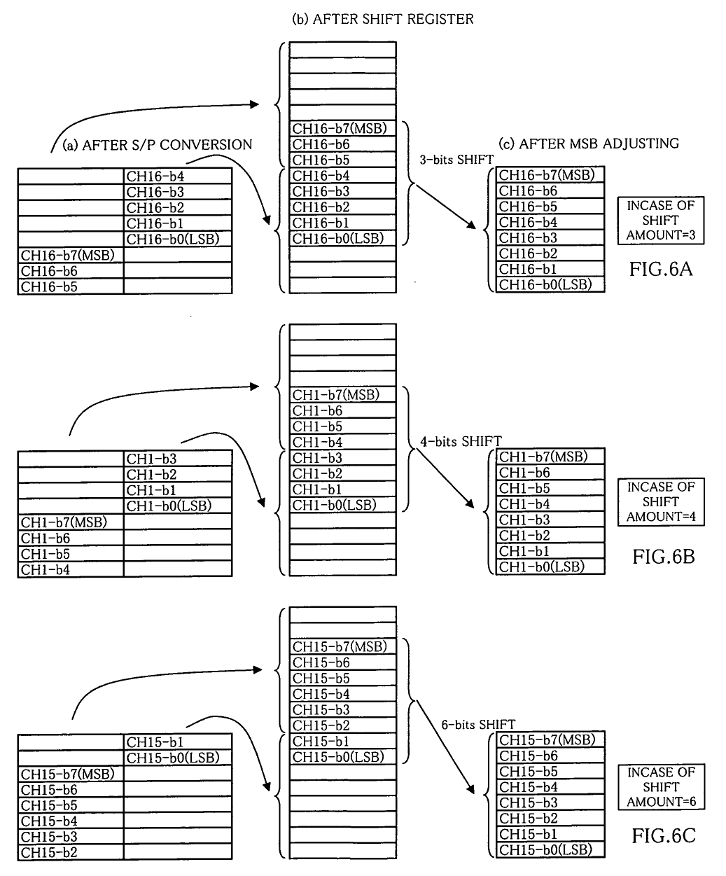

Also, the MSB adjusting circuits 13_1 and 13_2 perform an operation as shown in FIGS. 6A-6C.

The MSB adjusting circuits 13_1 and 13_2 are respectively composed of shift registers 13_1a and 13_2a and selectors 13_1b and 13_2b as shown in FIG. 4. When the signals are transmitted to the shift registers 13_1a and 13_2a after the S/P conversion of the S/P conversion circuit 11 shown in a portion (a) of FIG. 6A, the signals are accumulated in 16-bit data as shown in a portion (b) of FIG. 6A. At this time, the reception of the MSB timing signal from the MSB timing generator 12_1f indicates how many bits the channel signal having been just received is shifted by. Therefore, in case of a shift amount=3 in FIG. 6A, data to which the MSB adjusting is performed in a state where lower 3 bits of the LSB (least significant bits) are shifted can be obtained as shown in a portion (c) of FIG. 6A. This is similarly executed in case of the shift amount=4 and the shift amount=6 in FIGS. 6B and 6C.

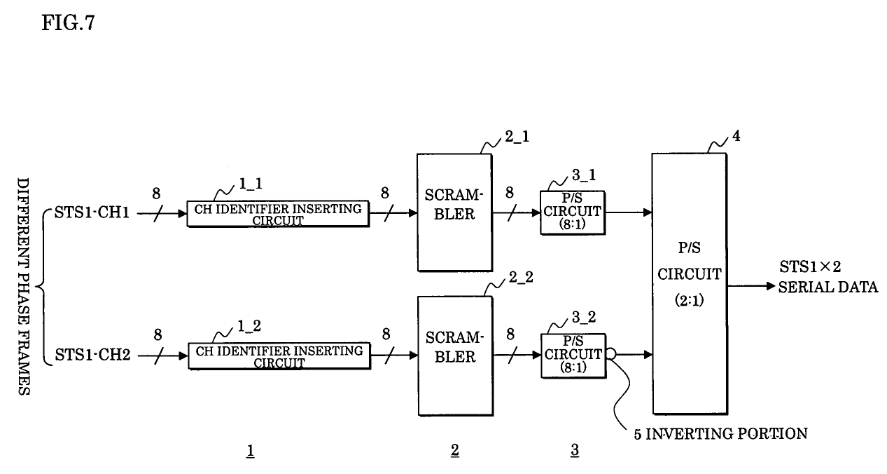

### Embodiment [2] of Frame Transmitting Device: FIG. 7

The basic arrangement of this frame transmitting device is the same as that of the frame transmitting device of the embodiment [1] shown in FIG. 1 except that an inverting portion 5 is provided on the output side of the P/S conversion circuit 3_2 in one channel CH2.

Before the conversion into the STS1 serial data for the two channels in the P/S conversion circuit 4, the polarity of the STS1 frame of one channel CH2 is inverted to avoid the continuity of the same code upon the multiplexing.

Namely, scrambling is not applied to frame information such as an A1 byte, an A2 byte, and a J0 byte by the scrambler 2. Therefore, when the phases of the STS1-CH1 and the STS1-CH2 frame signals happen to be consistent with each other and besides bit-multiplexing is performed in the P/S conversion circuit 4, the frame information of the same pattern is to continue for the number of channels, so that there is a possibility that a mark ratio of the signal is reduced. In order to avoid this, data inversion processing is performed by providing the inverting portion 5, whereby the reduction of the mark ratio is prevented.

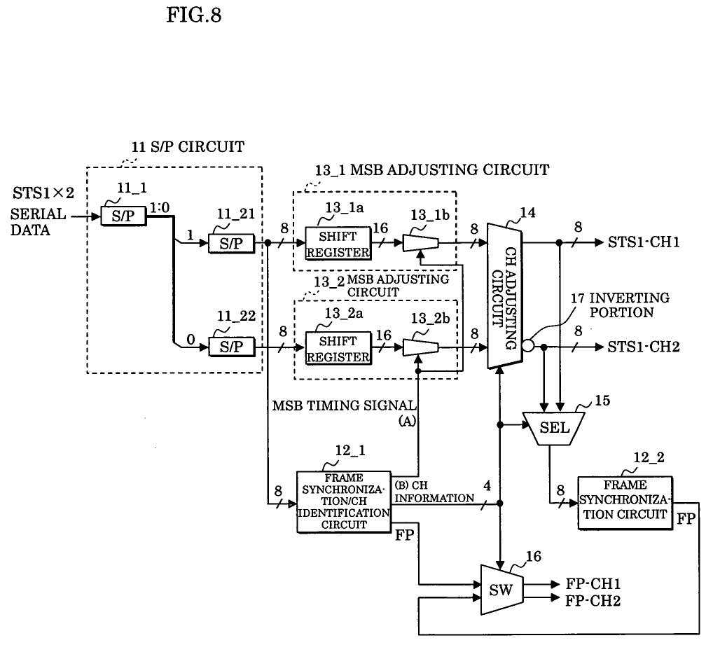

### Embodiment [2] of the Frame Receiving Device: FIG. 8

This frame receiving device, corresponding to a frame transmitting device of the above-mentioned FIG. 7, is different from that of the embodiment [1] in that an inverting portion 17 is provided on the output side of one channel CH2 of the CH adjusting circuit 14.

Namely, on the transmission side, the frame patterns shown in the above-mentioned Table 2, A1 byte=“11110110” (F6) and A2 byte=“00101000” (28), as well as inverted frame patterns of A1 byte=“00001001” (09) and A2 byte=“11010111” (D7) are also transmitted as the frame patterns.

Corresponding to this transmission, the frame receiving device detects A1A2=F628 at the frame synchronization/CH identification circuit 12_1 as the frame pattern to identify the channel as mentioned above. The CH adjusting circuit 14 performs the channel adjusting (matching) with this CH identifier, so that the STS1 frame signal of one channel CH1 is transmitted from the upper side of the CH adjusting circuit 14.

The STS1 frame signal of the channel CH2 outputted from the lower side of the CH adjusting circuit 14 is outputted after the inversion processing by the inverting portion 17. When the STS1 frame signal is provided to the selector 15, the selector 15 selects the STS1-CH2 frame signal based on the CH identifier to be provided to the frame synchronization circuit 12_2. The frame synchronization circuit 12_2 detects A1A2=09D7 as the frame pattern to be outputted to the switch circuit 16, thereby obtaining the STS1 frame signal in the same way as the transmission side.

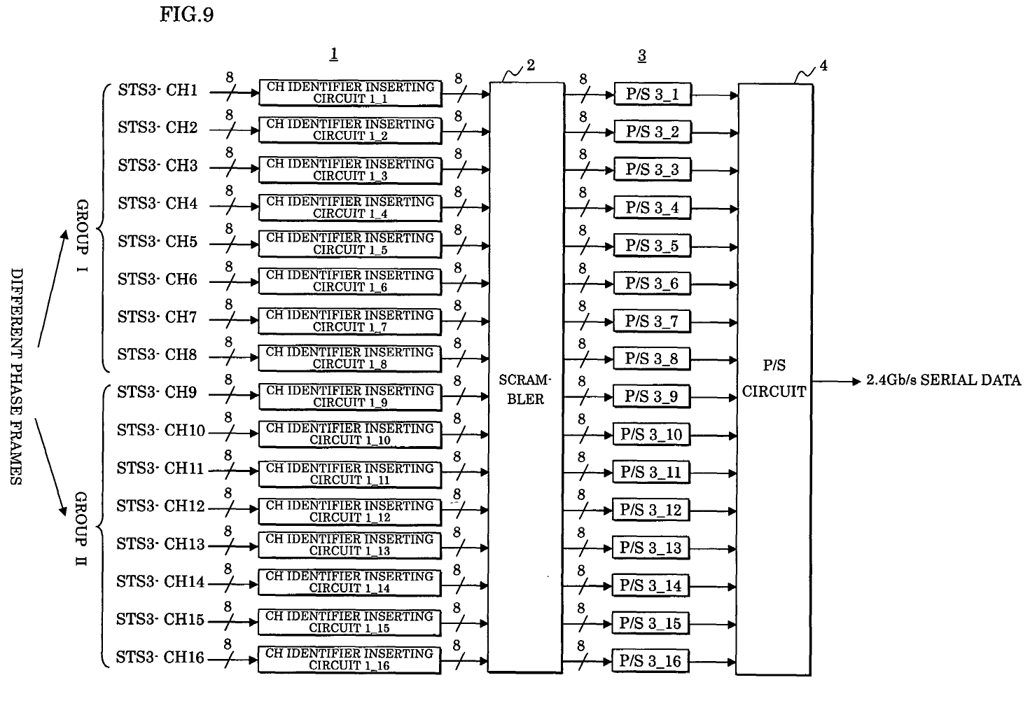

### Embodiment [3] of Frame Transmitting Device: FIG. 9

While the embodiment [1] shown in FIG. 1 treats the STS1 frame, this embodiment [3] treats a pseudo STS3 frame of 150 Mb/s. Namely in this embodiment, there are two groups of parallel data to which bit-multiplexing for 8 channels is performed respectively. The groups I and II with the phase difference are bit-multiplexed and transmitted as 2.4 Gb/s serial data.

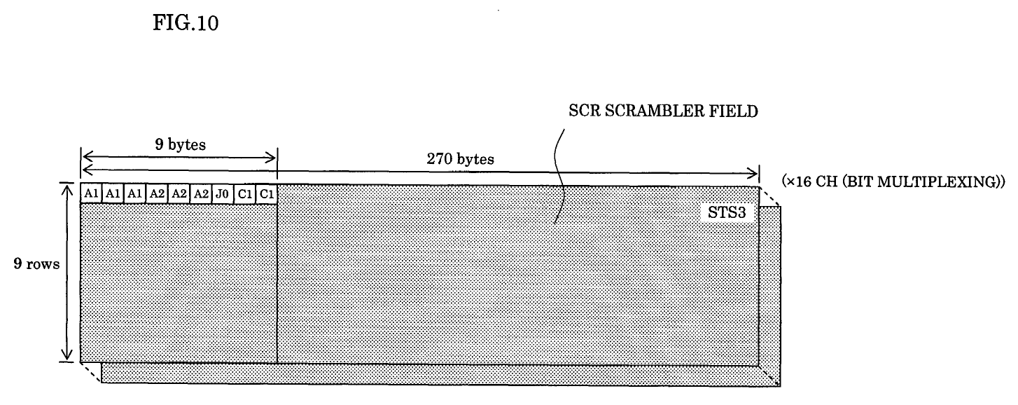

The STS3-CH1-STS3-CH16 frames that are input signals of the frame transmitting device shown in FIG. 9 have 16 channels of the STS3 frames with 9 rows×270 bytes per channel, inputted in parallel as shown in FIG. 10.

Firstly, in the group I where the frames are in phase, STS3-CH1-STS3-CH8 frames are inputted to the CH identifier inserting circuits 1_1-1_8 (respectively corresponding to the CH identifier inserting circuit 1_1 in FIG. 1) as each 8-bit parallel data, so that the CH identifiers are inserted into the least significant 4 bits of the J0 byte as shown in the following Table 3.

TABLE 3

| LEAST SIGNIFICANT 4 | CH |
|---|---|
| BITS OF J0 BYTE | IDENTIFICATION |
| 0000 | CH1 |
| 0001 | CH2 |
| 0010 | CH3 |
| 0011 | CH4 |
| 0100 | CH5 |
| 0101 | CH6 |
| 0110 | CH7 |
| 0111 | CH8 |
| 1000 | CH9 |
| 1001 | CH10 |
| 1010 | CH11 |
| 1011 | CH12 |
| 1100 | CH13 |
| 1101 | CH14 |
| 1110 | CH15 |
| 1111 | CH16 |

On the other hand, in the group II whose phase is different from that of the group I, the STS3-CH9-STS3-CH16 frames are similarly inputted to the CH identifier inserting circuits 1_9-1_16, so that the CH identifiers are similarly inserted into the least significant 4 bits of the J0 byte as shown in the above Table 3.

The outputs of these CH identifier inserting circuits 1_1-1_16 (hereinafter, occasionally represented by a reference numeral “1”) are transmitted to the scrambler 2. The scrambler 2, (each scrambler per channel is not shown), is provided for each channel in the same way as the scramblers 2 in FIG. 1. Scrambling is performed to a scrambler field SCR shown by hatching in the STS3 frame in each channel outputted from each CH identifier inserting circuit 1, so that the outputs are respectively transmitted to the P/S conversion circuits 3_1-3_16 in the form of the 8-bit parallel CH data.

Each 8-bit parallel data output of the scrambler 2 is converted into the serial data by the P/S conversion circuits 3_1-3_16 (hereinafter, occasionally represented by a reference numeral “3”), so that bit-multiplexing is further performed to the serial data by the P/S conversion circuit 4 to be transmitted as 2.4 Gb/s serial data.

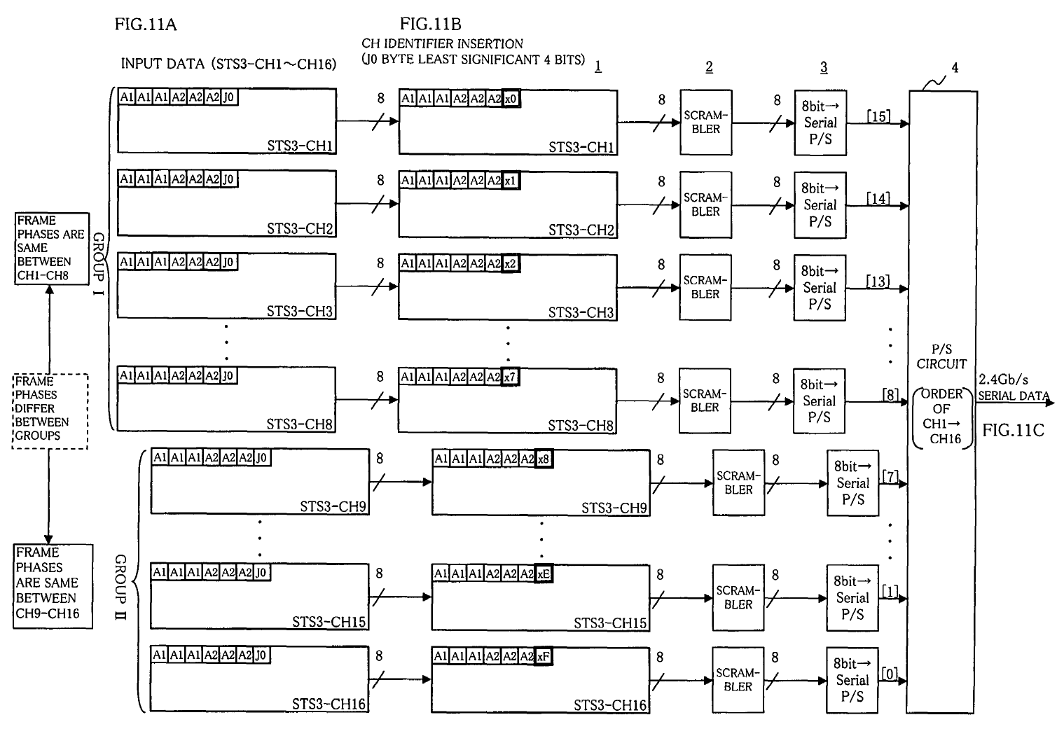

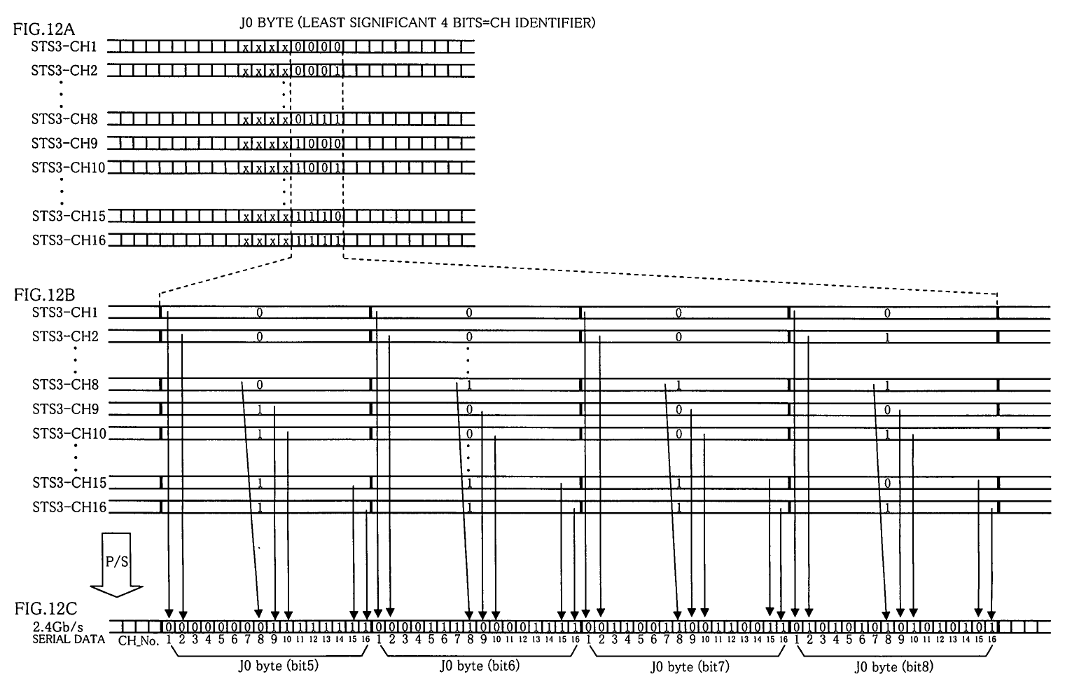

The operation of the frame transmitting device shown in FIG. 9 will now be described in more detail referring to FIGS. 11A, 11B, and 12A-12C.

Firstly, FIG. 11A shows a state where a shift of the phases of the input data of the STS3-CH1-STS3-CH16 exists between the group (system) I and the group II. As shown in FIG. 11B, the CH identifier inserting circuit 1 inserts the CH identifier as shown in the above Table 3 into the least significant 4 bits of the J0 byte in each of the STS3 channel shown in FIG. 10, in the input data of the group I and the group II. This state is shown by boxes with thick lines of FIG. 11B.

Hereafter, the 8-bit parallel data outputted from the CH identifier inserting circuit 1 in each of the channels CH1-CH16 is transmitted to the P/S conversion circuit 4 through the scrambler 2 and the P/S conversion circuit 3. In the P/S conversion circuit 4, bit-multiplexing is further performed in the order of the channels CH1 to CH16 to the serial data converted by the P/S conversion circuit 3. Then, the serial data is outputted in the form of 2.4 Gb/s serial data as shown in FIG. 11C.

FIGS. 12A-12C show a serial/parallel conversion operation example in the P/S conversion circuit 4. Namely, in the serial data of each of the channels CH1-CH16 from the P/S conversion circuit 3, the CH identifier is inserted into the least significant 4 bits of the J0 byte in the form shown in FIG. 12A where FIG. 12B shows these 4 bits enlarged. The P/S conversion circuit 4 having inputted such STS1-CH1 data-STS1-CH16 data performs bit-multiplexing to the data in the order of the channels CH1 to CH16 to be transmitted in the form of 2.4 Gb/s serial data shown in FIG. 12C.

It is to be noted that FIG. 12C only shows the part of the least significant 4 bits (5th bit to 8th bit) of the J0 byte while other parts are omitted. Also, while FIG. 11A shows the STS1-CH1-STS1-CH16 with a phase shift included, FIG. 12C omits the phase shift in order to simplify the figure. This is because the phase shift is not adjusted in the present invention, so that the essence of the invention is not affected even if the phase shift is omitted.

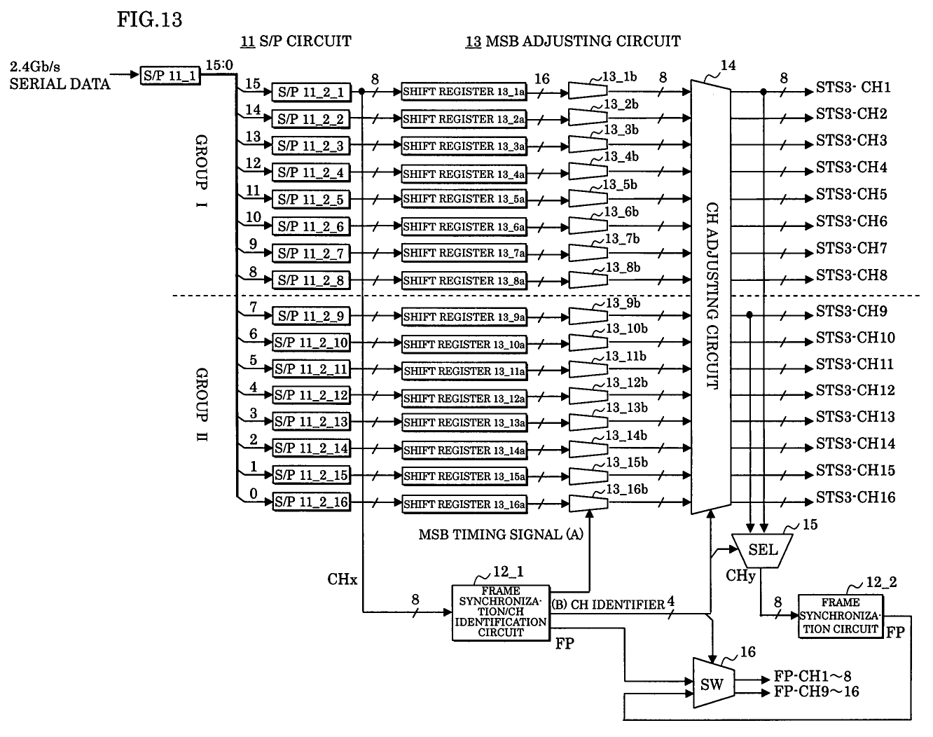

### Embodiment [3] of Frame Receiving Device: FIG. 13

The embodiment of this frame receiving device corresponds to the embodiment [3] of the frame transmitting device shown in FIG. 9. Namely, the 2.4 Gb/s serial data transmitted from the frame transmitting device is demultiplexed into 16 parallel data the same as the number of channels bit-multiplexed (channel-multiplexed) by the S/P conversion circuit 11_1. The 16 parallel data includes group I and group II.

In order to make the rate of the 16 parallel data easy to be processed, 8-bit parallel data is made by further using S/P conversion circuits 11_2_1-11_2_16.

The 8-bit parallel data outputted from the S/P conversion circuits 11_2_1-11_2_16 is respectively accumulated on 16-bit data in the shift registers 13_1a-13_16a composing the MSB adjusting circuit 13, in which the MSB adjusting is further performed based on the MSB timing signal (A) from the frame synchronization/CH identifier circuit 12_1 in selectors 13_1b-13_16b composing the MSB adjusting circuit 13 to be transmitted to the CH adjusting circuit 14.

It is to be noted that the frame synchronization/CH identification circuit 12_1, as shown in FIG. 3, is for outputting the frame pattern FP, the MSB timing signal (A), and the CH identifier (B) with a single channel signal (in this example, 8-bit output data of S/P conversion circuit 11_2_1) as input data. The frame synchronization condition at this time is shown in the following Table 4. The Table 4 is different from Table 2 in that the frame pattern is 32 bits of A1 byte and A2 byte.

TABLE 4

| FRAME SYNCHRONIZATION | PATTERN RETRIEVAL | SYNCHRONIZATION |
|---|---|---|
| PATTERN | METHOD | PROTECTION |
| A1: 11110110 A2: 00101000 | 1-BIT IMMEDIATE SHIFT | FORWARD 5 STAGES |
| OR | METHOD | BACKWARD 2 STAGES |
| A1: 00001001 A2: 11010111 | 32 BITS OF A1 & A2 BYTES | INCLUDING |
| WAITING FOR BOTH | CONCURRENT CHECKING | CONSISTENCY OF LEAST |
| PATTERNS ONLY UPON | METHOD | SIGNIFICANT 4 BITS OF |
| HUNTING & MAKING | | J0 IN PROTECTION |
| FORMERLY DETECTED | | |
| PATTERN RETRIEVAL | | |
| PATTERN | | |

The CH adjusting circuit 14 having received the 8-bit parallel data from the selectors 13_1b-13_16b executes the channel rearrangement based on the 4-bit CH identifier (B) from the frame synchronization/CH identification circuit 12_1.

As a result, the STS3-CH1-STS3-CH16 are rearranged in the same channel relationship as the transmitting data shown in FIGS. 9, 11A, and 11B to be outputted from the CH adjusting circuit 14.

Based on the CH identifier (B), the selector 15 can recognize based on its memory which channel should be selected corresponding to either group of the channels STS3-CH1 and the STS3-CH9 presently inputted. Therefore, the selector 15 selects a channel signal of a group other than the group of the channel signal presently selected to be transmitted to the frame synchronization circuit 12_2.

The frame synchronization circuit 12_2 detects the frame pattern FP as described in FIG. 3 based on the 8-bit parallel data from the selector 15 to be transmitted to the switch circuit 16. The switch circuit 16 inputs the frame pulse FP from the frame synchronization/CH identification circuit 12_1. Since the switch circuit 16 can recognize from its memory to which group the frame pattern FP presently selected belongs based on the CH identifier (B), it is rearranged such that the upper side is made a frame pattern of the channels CH1-CH8 of the group I, and the lower side is made a frame pattern of the channels CH9-CH16 of the group II outputted.

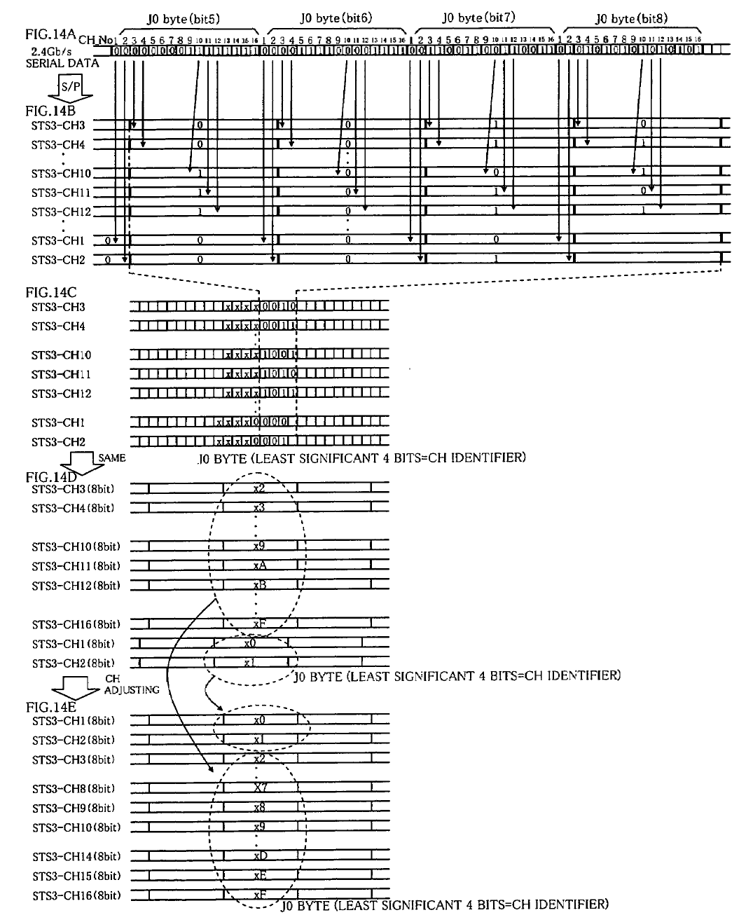

FIGS. 14A-14E show in detail the operation example of the frame receiving device. Namely, 2.4 Gb/s serial data (corresponding to serial data on the transmission side shown in FIG. 12C) as shown in FIG. 14A is inputted, so that the S/P conversion circuit 11 converts the serial data into the parallel data as shown in FIG. 14B. In this operation example, it is supposed that the STS3-CH3 frame data has appeared in the first channel as a result that the channel relationship has been shifted in the transmission line, as shown in FIG. 14B. Namely, FIG. 14B shows a case where the CH identifier extracted by the frame synchronization/CH identification circuit 12_1 is “0010” (CH3) after the serial/parallel conversion by the S/P conversion circuit 11. Also, FIG. 14B shows that the STS3-CH1 and the STS3-CH2 frame data have appeared in the 2nd and the 1st channel from the bottom.

FIG. 14C shows them in a compressed manner, in which only the least significant 4 bits (CH identifier) of the J0 byte are specifically and briefly shown. The parallel data of the STS3-CH3-STS3-CH2 shown in FIG. 14C is the data of STS3-CH1 and STS3-CH2 to which the S/P conversion is performed with one bit shift, as shown. Therefore, if the data is equivalently shown, a frame form shown in FIG. 14D is obtained, where J0 bytes assume “x2”, “x3”, . . . “x9”, “xA”, “xB”, . . . “xF”, “x0”, and “x1”.

When the channel adjusting is executed in the CH adjusting circuit 14, as shown in FIG. 14E, the frame data of the STS3-CH1 and the STS3-CH2 are rearranged on the upper side of the frame data of the STS3-CH3, and a bit position is adjusted, so that the frame data from the STS3-CH1 frame to STS3-CH16 frame which are the same as the frame data on the transmission side can be obtained.

It is to be noted that the MSB adjusting in the operation example in FIGS. 14A-14E and the phase shift between the groups I and II shown in FIG. 1A are not specifically shown for simplifying the figure.

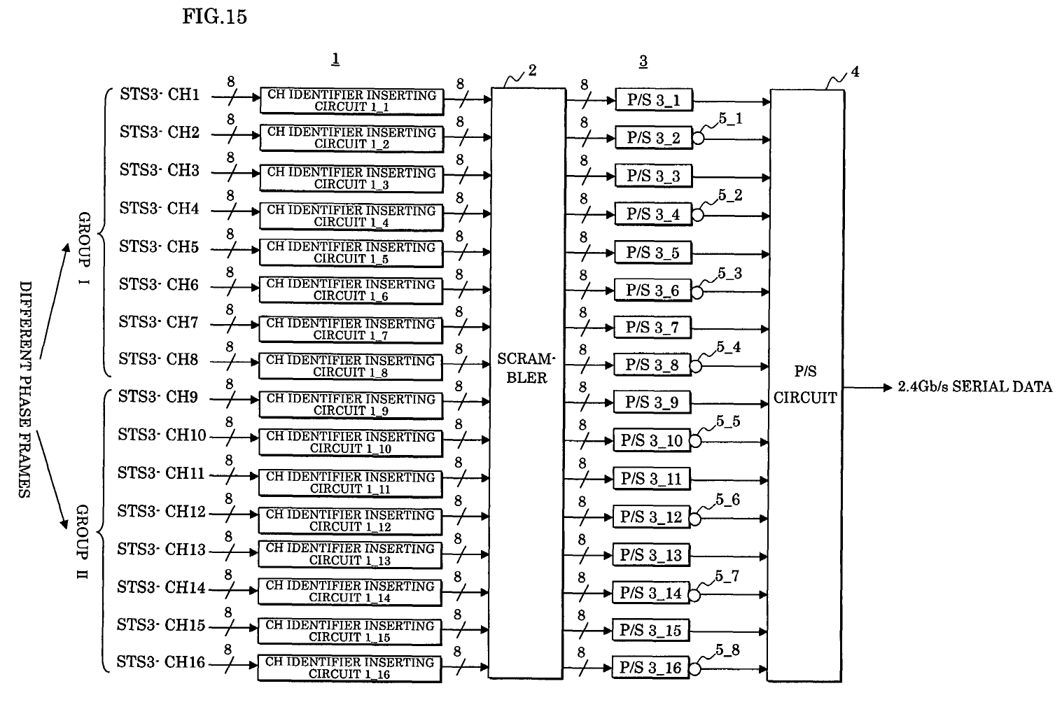

### Embodiment [4] of the Frame Transmitting Device: FIG. 15

This frame transmitting device is different from that of the embodiment [3] shown in FIG. 9 in that the output data of the P/S conversion circuits 3_2, 3_4, 3_6, 3_8, 3_10, 3_12, 3_14, 3_16 of even channels in the P/S conversion circuit 3 are inverted by inverting portions 5_1-5_8 to be provided to the P/S conversion circuit 4 since every other channel is code-inverted when the two groups of the channels STS3-CH1-STS3-CH8 and the STS3-CH9-STS3-CH16 are bit-multiplexed into serial data with the phase difference.

Thus, as described in the embodiment [2] of FIG. 7, by providing the inverting portions 5_1-5_8, the frame channels which are same patterns as the case where phases of the STS3 frame signals happen to be consistent continue for the number of channels, thereby enabling the state where the mark ratio is reduced to be prevented.

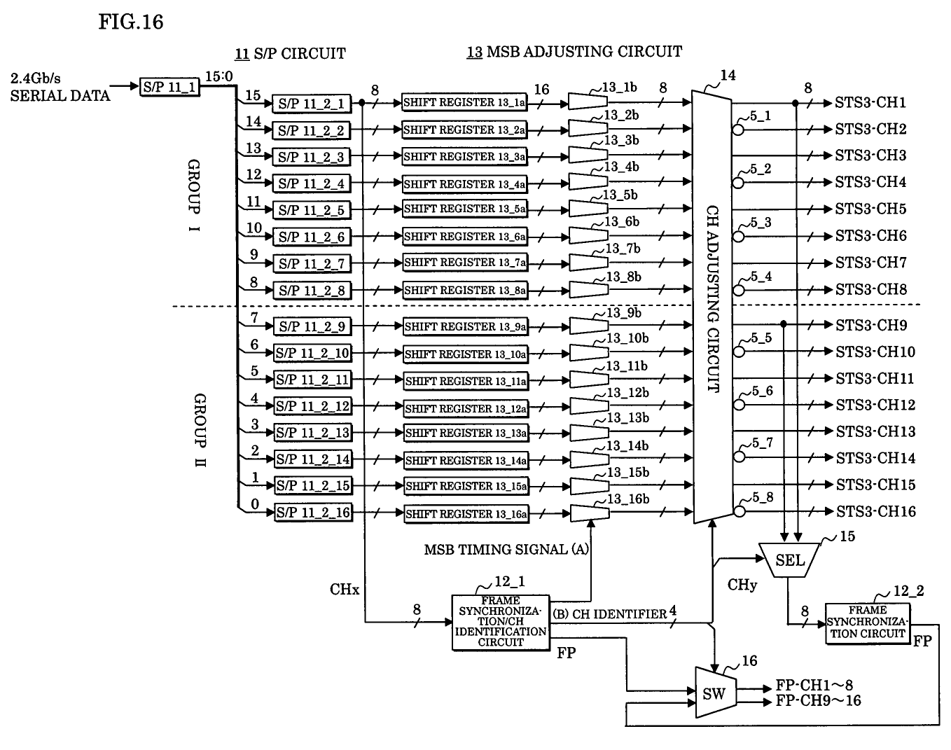

### Embodiment [4] of frame receiving device: FIG. 16

This frame receiving device corresponds to the frame transmitting device shown in FIG. 15. The inverting portions 5_1-5_8 are provided to the output terminal of even channels of the CH adjusting circuit 14 in the embodiment [3] of the frame receiving device shown in FIG. 13.

Namely, as mentioned above, the input serial data is S/P converted by the S/P conversion circuit 11, and then the frame pattern is detected in the frame synchronization/CH identification circuit 12_1. At that time, as mentioned in the above Table 4, two types of frame patterns detected, i.e. A1A2 =“F628” (non-inverted) and “09D7” (inverted) exist. With the CH identifier (B) detected, the channel identification is performed based on the above Table 3, and the channel adjusting is further performed by the CH adjusting circuit 14. The data inversion processing is performed to every other channel (every even channel) at the inverting portions 5_1-5_8 to output the STS3-CH1-STS3-CH16 frame data.

It is to be noted that the present invention is not limited by the above-mentioned embodiments, and it is obvious that various modifications may be made by one skilled in the art based on the recitation of the claims.

What is claimed is:

1. A frame transmitting method comprising:
a first step of inserting a channel identifier without a phase adjustment into predetermined free bytes of parallel channel signals whose phases are different from each other; and
a second step of converting the parallel channel signals into a serial signal.

2. A frame receiving method comprising:
a first step of converting a serial signal whose phase is not adjusted on a transmission side into parallel channel signals;
a second step of detecting a frame pattern from a single channel signal within the parallel channel signals to detect a channel identifier inserted into a predetermined free byte of the single channel signal; and
a third step of rearranging channels between all of the parallel channel signals without a phase adjustment, based on the channel identifier.

3. The frame transmitting method as claimed in claim 1, wherein the second step includes a step of inverting signals of odd number channels or even number channels within the parallel channel signals and then converting the signals into the serial signal.

4. The frame receiving method as claimed in claim 2, wherein the third step includes a step of further inverting signals of odd number channels or even number channels within all of the channel signals rearranged.

5. The frame receiving method as claimed in claim 2, further comprising a fourth step of detecting another corresponding frame pattern from a single channel signal within groups other than a group to which the single channel signal belongs among predetermined m (m≧2) number of groups whose phases are different from each other, composing the parallel channel signals; and
a fifth step of rearranging the frame patterns detected at the second and fourth step respectively, based on the channel identifier.

6. The frame receiving method as claimed in claim 2, further comprising a sixth step of generating an MSB timing based on the frame pattern detected at the second step; and
a seventh step of performing MSB adjusting of the parallel channel signals based on the MSB timing before the channel rearrangement at the third step.

7. The frame transmitting method as claimed in claim 1, wherein the parallel channel signal and the serial signal are signals of STS-N (N=1, 3, . . . ) or STM-N (N=0, 1, . . . ).

8. The frame receiving method as claimed in claim 2, wherein the parallel channel signal and the serial signal are signals of STS-N (N=1, 3, . . . ) or STM-N (N=0, 1, . . . ).

9. A frame transmitting device comprising:
a first means inserting a channel identifier without a phase adjustment into predetermined free bytes of parallel channel signals whose phases are different from each other; and
a second means converting the parallel channel signals into a serial signal.

10. A frame receiving device comprising:
a first means converting a serial signal whose phase is not adjusted on a transmission side into parallel channel signals;
a second means detecting a frame pattern from a single channel signal within the parallel channel signals to detect a channel identifier inserted into a predetermined free byte of the single channel signal; and
a third means rearranging channels between all of the parallel channel signals without a phase adjustment, based on the channel identifier.

11. The frame transmitting device as claimed in claim 9, wherein the second means includes a means inverting signals of odd number channels or even number channels within the parallel channel signals and then converting the signals into the serial signal.

12. The frame receiving device as claimed in claim 10, wherein the third means includes a means further inverting signals of odd number channels or even number channels within all of the channel signals rearranged.

13. The frame receiving device as claimed in claim 10, further comprising a fourth means detecting another corresponding frame pattern from a single channel signal within groups other than a group to which the single channel signal belongs among predetermined m (m≧2) number of groups whose phases are different from each other, composing the parallel channel signals; and
a fifth means rearranging the frame patterns detected by the second and fourth means respectively, based on the channel identifier.

14. The frame receiving device as claimed in claim 10, further comprising a sixth means generating an MSB timing based on the frame pattern detected by the second means; and
a seventh means performing MSB adjusting of the parallel channel signals based on the MSB timing before the channel rearrangement by the third means.

15. The frame transmitting device as claimed in claim 9, wherein the parallel channel signal and the serial signal are signals of STS-N (N=1, 3, . . . ) or STM-N (N=0, 1, . . . ).

16. The frame receiving device as claimed in claim 10, wherein the parallel channel signal and the serial signal are signals of STS-N (N=1, 3, . . . ) or STM-N (N=0, 1, . . . ).
